(19) United States
(12) Patent Application Publication
(10) Pub. No.: US 2014/0283437 A1
(43) Pub. Date: Sep. 25, 2014

(54) Insect Extermination Device

(71) Applicant: Robert BRANNON, Pinnacle, NC (US)

(72) Inventor: Robert L. Brannon, East Bend, NC (US)

(21) Appl. No.: 14/352,333

(22) PCT Filed: Oct. 17, 2012
(86) PCT No.: PCT/US12/60541

§ 371 Date: Apr. 17, 2014

Related U.S. Application Data
(60) Provisional application No. 61/547,874, filed on Oct. 17, 2011.

(51) Int. Cl. A01M 1/02

(52) U.S. Cl. CPC A01M 1/023
USPC 43/132.1

(57) ABSTRACT

Herein described is an insect exterminating device. The device has interconnecting tubing segments comprising a gas tubing line and a liquid tubing line which allows the flow of substances there through. The device additionally comprises a tube support assembly for convenient attachment of tubing segments to solid support structures.

### RELATED APPLICATION

This application claims priority to U.S. Provisional Patent Application 61/547,874, filed Oct. 17, 2011. The disclosure of U.S. Provisional Patent Application 61/547,874 is incorporated by reference herein in its entirety.

### FIELD OF THE INVENTION

The present invention relates to an insect extermination device for use within a defined, contained space and attachable to structures within said space.

### BACKGROUND OF THE INVENTION

Bedbugs (Cimex lectularius) are a most disagreeable houseguest because of their gruesome habits. They are obligate blood suckers. Bed bugs frequently feed on human blood, but they don't discriminate as other animals fall victim to their habits as well including birds and mice. Bed bugs are attracted by warmth and carbon dioxide. Bed bugs mainly feed at night when people are asleep injecting an anticoagulant into the wound and then using its probisci to suck the blood out of the opening. The bugs pierce the skin with two hollow tubes, one of which injects anti-coagulants into the wound and the other withdraws the blood. Frequently the bite becomes irritated due to the immune system reacting to the injection of anticoagulants and other substances, including proteins with reaction taking from a few minutes to several weeks to appear.

Adult bed bugs are usually no more than ¼ inch in length, oval in shape, and flat, which allows them to gain access and hide inside very tight spaces. They are usually brown; however once they've fed they turn a dark red color. In their adult state they can engorge themselves with human blood in less than 15 minutes causing their bodies to fill to as much as three times its usual size. Fully engorged bed bugs bear little resemblance to their original state and are often thought to be a different insect altogether. A well fed bug can live anywhere from four to six months, while a dormant one might live without feeding for up to 18 months.

Bed bugs are very cryptic insects. They like to hide in the cracks in walls and ceilings, electrical outlets, behind wall paper, inside base boards, behind picture frames, between beds, and around the creases of mattresses and in bedding material. Common harborages in hotel rooms and cruise ship cabins include folds and creases in bed linens, seams, tufts and under buttons on mattresses, in draper pleats and hems, beneath loose wallpaper, in headboards, desks, entertainment centers and nightstands, behind base molding in wall-mounted artwork.

Bed bugs can lay between one and ten eggs per day with an incubation period of 7-10 days in warm weather. These newly hatched bed bugs will require five significant blood feedings to reach adult size. They will molt in between feedings by shedding their exoskeleton. Once mature, they will begin the process of laying new eggs. Adult female bed bugs can lay more than 200 eggs during their lifetime and the new generation of bed bugs will immediately seek a blood meal.

There are other types of bugs closely related to and sometimes mistaken for the bedbug including the bat bug, the chimney swift bug and the swallow bug, all of which also survive by blood feeding; however The bed bug is the only one that regularly feeds on humans.

Bed bugs have been around for centuries. Documentation reaching as far back as the 17^{th} century describes bed bug infestations in great detail. In the United States, bed bugs were very common until around the 1950's, when pesticides such as DDT were introduced. With the introduction of these pesticides came an enormous reduction in infestations, but over the last decade bed bug infestations have rebounded significantly. Much of the blame for the resurgence is attributed to environmental regulations banning effective pesticides like DDT due to their negative health and environmental impact. Exterminating tactics used today may also contribute. Today, many pest control experts use baiting tactics for in home infestations of such things as ants, roaches, and spiders. These baiting tactics work well for their intended subjects, but since bed bugs are blood feeders, they do not fall for the baiting tricks used.

What is needed is an extermination device that exploits certain natural characteristics of the bed bug, such as its attraction to warmth and carbon dioxide, that is conveniently attachable to objects that receive substantial human use, and that utilizes active agents that are non-toxic and not harmful to the environment.

### SUMMARY OF THE INVENTION

Further scope of applicability of the present invention will become apparent from the detailed description given herein. However, it should be understood that the detailed description and specific examples, while indicating embodiments of the invention, are given by way of illustration only, since various changes and modifications within the spirit and scope of the invention will become apparent to those skilled in the art.

The insect exterminating device of the present invention comprises a series of interconnecting tubing segments connected by connector members. In one embodiment the connector is a male and female threaded joint, which allows one tubing segment to be screwed into another tubing segment. The interconnecting tubing segments may be a single line or multiple lines. In one embodiment, the interconnecting tubing segments comprise two discrete tube lines, a gas tubing line and a liquid tubing line. The insect exterminating device further contains a liquid and gas supply. In one embodiment, the liquid and gas supply are together as one unit, but with two independent reservoirs. In another embodiment, the insect exterminating device may contain multiple liquid and gas supplies positioned as needed based in part on span of coverage, such as size of room and number of solid structures. In one embodiment the liquid and gas supplies are pressure controlled and/or temperature controlled. In another embodiment, the liquid and gas supplies comprise a timing mechanism for release of liquid and gas substances based on target insect behavioral characteristics. The insect exterminating device of the present invention further comprises a tubing support assembly for attaching the interconnecting tubing segments to solid support structures within a space. The tubing support assembly may comprise a tube support wherein the tubing segments are held in place and positioned against the solid support structure.

The gas substance which flows through the gas line of the present invention may be carbon dioxide or some other compound that is known to attract insects, such as bed bugs. The gas substance may also contain hormones or pheromones. The liquid substance which flows through the liquid line of the present invention may comprise a mixture of chemical toxicants, biological agents such as fungi, viruses, or bacteria, or other compound known to be a toxicant to insects as well as other water soluble constituents, such as tracking dyes, de-foaming agents, leak stopping agents, UV-florescent tracking dyes, blood simulating agents and the like.

### BRIEF DESCRIPTION OF THE FIGURES

An embodiment of the invention will now be described with reference to the accompanying drawings, in which:

FIG. 1 illustrates an embodiment of the insect exterminating device attached to a bed with other components shown.

FIG. 2 illustrates an embodiment of tubing segments with connectors.

FIG. 3 illustrates an embodiment of as unit containing a liquid and gas supply.

FIG. 4 illustrates an embodiment of a tube support assembly fitted for a bed box spring mattress.

FIG. 5 illustrates an embodiment of an insect trap.

FIG. 6 illustrates an embodiment of a standalone insect extermination device.

### DETAILED DESCRIPTION OF THE INVENTION

The term “controlling” as used herein refers to monitoring and/or exterminating blood feeding insects such as bed bugs. The term, “active agent” as used herein refers to any chemical or substance haying either attractant or toxicant properties for insects. “Active agents” include but are not limited to boric acid, citric acid, sodium chloride, sodium lauryl sulfate, indoxacarb, halogenated pyroles, such as chlorophenapyr and pyrethrin, pyrethroids, such as bioallethrin, tetramethrin, permethhrin, cypermethrin, resmethrin, bioresmethrin, deltamethrin, lambda cyhalothrin, carbamates, such as aldicarb, bendiocarb, carbaryl, fenbucarb, fenoxycarb, methiocarb, methomyl, pirimicarb, 1-naphthol 2-isopropoxyphenol, carbofuranphenal, and carbofuran, octopamine inhibitors, phenylpyrazoles such as fipronil, and various biological agents such bacterium, viruses, fungi, other agents, such as antibiotics or any combination thereof.

It should be noted that, as used in the specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless content clearly dictates otherwise.

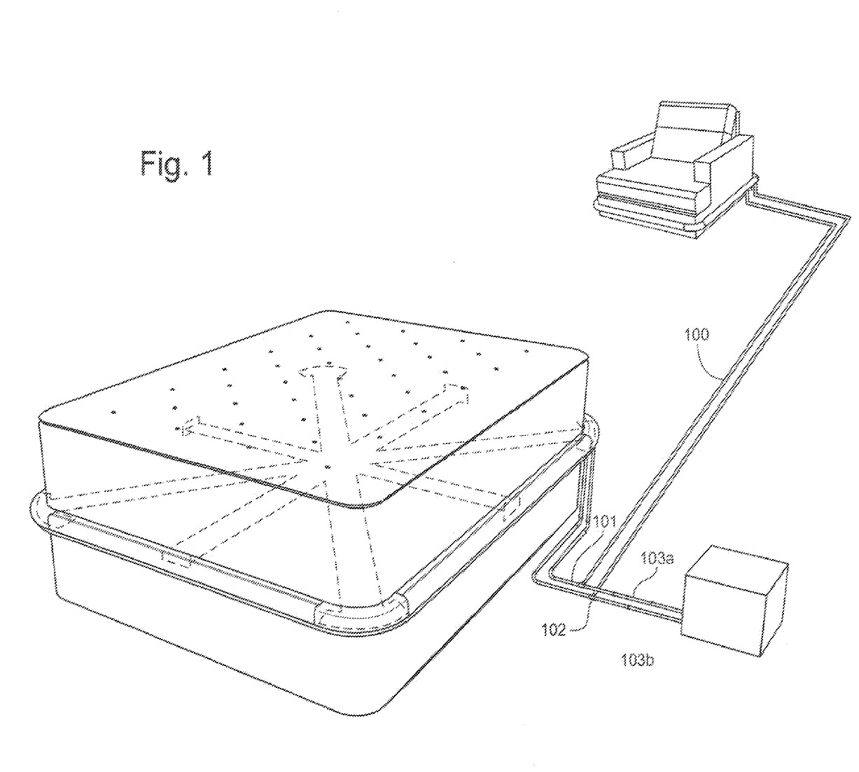

Referring now to FIG. 1, an embodiment of the insect extermination device is generally designated by the numeral 100 in the drawings. Although the embodiment is described for use with bed bugs, it is recognized that the insect extermination device 100 could be used with other types of insects, such as kissing bugs and mosquitoes.

The insect extermination device 100 shown in FIG. 1 is a non-free standing device wherein the tube segments 101 are attached to a bed via a tube support assembly and an attachable insect trap. For non-free standing devices, the insect extermination device 100 may be attached to any interior structure including but not limited to chairs, walls, base boards, tables, lamps, mattresses, box springs, and the like. The insect extermination device 100 comprises a series of connected tube segments 101 which may be of any size or shape as long as they promote the passage of a substance there through. The substance that flows through the tubing segments 101 may be a gas or liquid that may further comprise toxicants or attractants or mixtures thereof suitable for the purpose of this invention.

For example, in one embodiment, the gas substance may comprise carbon dioxide or sonic other gas compound known to attract insects, such as bed bugs. The gas substance may additionally comprise hormones or pheromones for additional attractant properties. The liquid substance may comprise a mixture of an active agent such as boric acid or another compound known to be a toxicant to insects such as bed bugs. For example, the liquid substance may comprise active agents and/or toxicants such as pesticides, salts, fungicides, antimicrobial agents, antiviral agents, and the like. Such active agents and/or toxicants may be water soluble. The liquid substance of the present invention may contain other water soluble constituents, such as tracking dyes, de-foaming agents, leak stopping agents, UV-florescent tracking dyes, blood simulating agents, and the like.

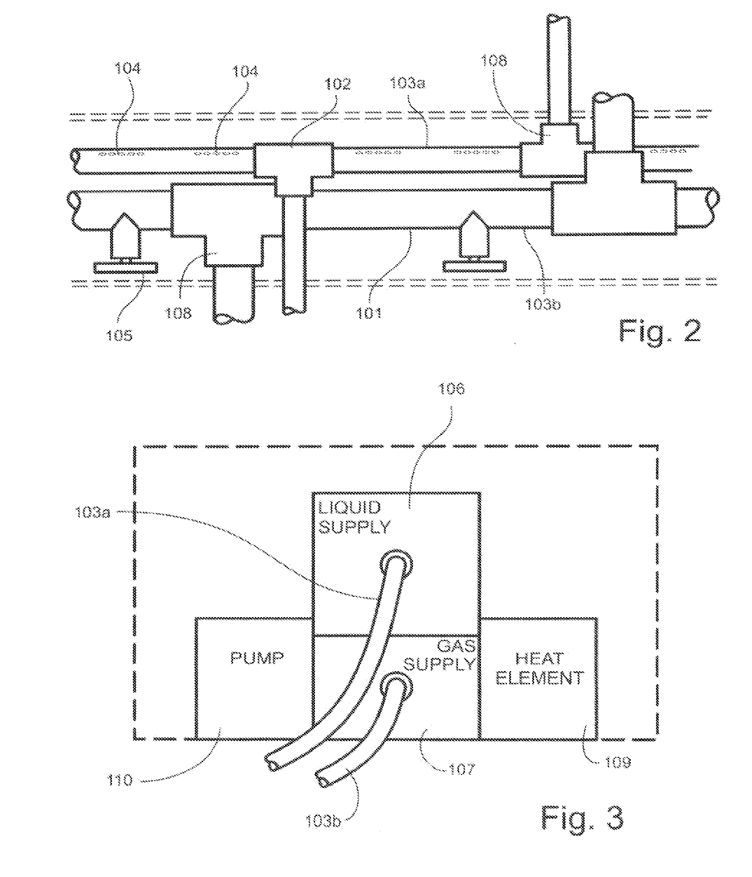

As illustrated in FIGS. 1 and 2, each tube segment 101 may be connected to one another by connector 102. Connector 102 may be any design known to those of skill in art that promotes flexibility and easy adjustment between tube segments 101 as well as the overall arrangement of the insect extermination device 100 within the covered interior space. Connector 102 should also allow passage of a liquid or gas substance through the connector 102 wherein the liquid or gas substance being used may pass from one segment to another, for example a male/female threaded, male/female bayonet, shark bites, cone, line, reducer connectors and the like. In one embodiment, the connector 102 comprise male/female joints or connections wherein each tubing segment 101 contains a male threaded joint at one end and a female threaded joint at the opposite end. The male joint comprises threads which engage female threaded counterparts of an adjoining tube segment.

The tube segments 101 may be made of flexible or rigid materials suitable for safely transporting liquid and gaseous substances at specified temperatures and pressures. Such materials include, but are not limited to PEX, PVC, ABS, and CPVC. The tube segments 101 additionally may be treated internally for chemical and heat resistance to prevent degradation or decomposition of the tubing interior and/or exterior surface.

In the embodiment illustrated in FIGS. 1 and 2, the insect extermination device 100 comprises two discrete lines 103a and 103b of connected tubing segments 101. Line 101a comprises a liquid tubing line through which a liquid substance flows. Likewise, line 103b comprises a gas tubing line through which a gas substance flows.

In one embodiment, liquid tubing line 103a may comprise certain design features designed to promote insect access to the liquid substance within the tubing segment 101a. Such design features are called access points 104. Access points 104 may be of any design known to those of skill in the art that allow an insect accessibility to the liquid substance with very little effort while hindering escape of the liquid substance from the tubing segment 101a by, for example, spillage or seepage. For example, the access point 104 shown in the embodiment illustrated in FIG. 1 is a small opening in the tubing segment 101a. The opening may be a pin hole or a slit or any opening large enough to allow an insect to access the liquid substance and therefore the active agent and/or toxicant. For example, in the case of bed bugs, the access point 104 is large enough to allow penetration of the bed bug's probisci and two hollow tubes into the tube and ingestion of the liquid substance. As mentioned above, in one embodiment the access points 104 are furthermore sufficiently small to prevent liquid substance from escaping the tubing segment 101a. To further prevent spillage or seepage of the liquid substance from tubing segment 101a, the access point 104 may comprise a protective covering, such as a self healing permeable membrane. Such a membrane must be penetrable by the insect's probisci or other anatomical structure used by the insect to penetrate the skin and ingest the blood of a host organism. An example of such a membrane is Parafilm®. The protective covering may also be manufactured of a material that simulates the skin of a host organism. Artificial skins are known in the art, including but not limited to autologous spray-on skin or seeded or unseeded collagen scaffolds and the like.

In one embodiment, gas tubing line 103b may comprise certain design features that allow controlled release of the gas from line 103b. Such design features are called release mechanisms 105 for the purposes of this invention. Release mechanisms 105 may be of any design known to those of skill in the art that allow controlled release of the gas into the surrounding environment. In one embodiment, release mechanisms 105 may be designed to release the gaseous substance into the environment upon some human physical through intentional or unintentional manipulation of the mechanism. For example, intentional physical manipulation may include an intentional act, such as physical contact with the hand and fingers. Unintentional physical manipulation may include an unintentional act, such as a shift in weight on a bed or chair causing, movement of the release mechanism 105. Said motion in turn may activate, the release mechanism 105 causing controlled release of the gas into the environment. Alternatively, release mechanism 105 may be designed to release the gaseous substance passively, but at a controlled rate and volume. For example, upon threshold pressure buildup in tubing segment 101b, the release mechanism 105 may be calibrated to release a defined volume of gas. Once the predetermined volume of gas is released, the release mechanism 105 may close preventing further gas from escaping until the threshold pressure is reached once again. The release mechanism 105 in tubing line 103b as depicted in FIG. 2 is a common valve with a lever for convenient manual opening and closing.

The liquid tubing line 103a and gas tubing line 103b are connected to liquid supply 106 and gas supply 107, respectively, which supply the gas and liquid substances to the tubing lines 103a and 103b. Supplies 106 and 107 may be readily replaceable, for example, when contents have been exhausted or when the substance has expired and become inactive or inert. Supplies 106 and 107 may also be refillable. Supplies 106 and 107 may further comprise timing devices that control when the liquid or gas substance is dispensed. For example, release of gas or liquid from supplies 106 and 107 may coincide with the natural daily feeding cycle of the target insect. In this embodiment, when the natural daily feeding cycle of the insect has expired, supply will automatically turn off allowing no more substance to be released. Release of gas or liquid from supplies 106 and 107 may also be at a continuous controlled flow rate to the tubing lines 103a and 103b.

Supplies 106 and 107 may comprise any supply mechanism known by those of ordinary skill in the art that has a substance containment reservoir, a release or dispensing mechanism, and is adapted to connect to the liquid or gas tubing lines 103a and 103b. Supplies 106 and 107 may be of the same or different design. The supplies may be stationed together in one overall unit with two containment reservoirs for gas and liquid. For example, the as supply 107 may be a common tank containing compressed carbon dioxide mixture and is connected to gas tubing line 103b by male/female connection. Gas supply 107 may contain a single gas or a mixture of different gases depending on the user's needs. The liquid supply 106 may comprise an enclosed containment reservoir that holds the liquid substance and connects to liquid tubing line 103a by male/female threaded connection. Multiple liquid and gas supplies 106 and 107 may also be used and positioned intermittently at the end of long runs or next to the supporting structure, such as a bed, a chair, or table.

In order to accommodate multiple objects within a room or space, tubing lines 103a and 103b may be divided as needed at splitters 108 producing a multidirectional tubing line capable of reaching multiple locations within the space. For example, this multidirectional aspect of the tubing lines will enable accommodation of spaces with a large number of beds, such as a military barracks or camp cabins. The splitters 108 may be designed in a variety of ways as long as they allow the gas or liquid substance to pass through without leakage. For example, the splitter 108 may be a basic plastic T-joint or simply a manufactured dividing point in the tubing material. In the embodiment illustrated in FIG. 2, the splitter 108 is attached to connector 102 and is a common T-joint structure.

In one embodiment of the present invention, the liquid supply 106 may be temperature controlled. For example, the liquid supply 106 may comprise a heating or cooling element 109 to adjust the temperature of the liquid substance to simulate various properties of the typical insect host target. By way of further example, the liquid supply 106 may heat the liquid substance to a temperature of 98.6° F. to simulate the average human physiological temperature. It will be noted, that a user may select a temperature of liquid substance that is specific to the target insect's host seeking behavior. For example, the surface temperature of human skin may vary significantly depending on anatomical location or whether the skin is in contact with insulating material, such as a bed spread, a sheet, clothing, blankets or the like. Other organisms may have higher physiological temperatures, such as rabbits which are estimated to be at 103° F. Thus, in one embodiment, the liquid substance temperature will be between about 94° F. to about 106° F. in order to cover the anticipated host temperature range. The heating element 109 may be any mechanism or device known to those of skill in the art. In one embodiment the heating element 109 utilizes electricity from as battery or other power source. In another embodiment, the heating element 109 comprises an indoor safe gas fuel, such as propane with a catalytic burner apparatus. In another embodiment, the tubing segments 101 themselves may contain heating or cooling element 109. For example, the tubing segments 101 may be wrapped with a thermo resistant wire to heat the liquid closer to the end point of consumption by the insect, especially in colder climates or rooms, for example electric heat tape or braided heat cable, or equivalent electric or non-electric insulation. In order to maintain consistent temperature, the tubing segments 101 may also be insulated.

The liquid supply 106 may further comprise a pumping apparatus 110 that promotes the controlled flow of liquid substance through the liquid tubing line 103a. The pumping apparatus 110 of the present invention will comprise a power source. In one embodiment the pumping apparatus 110 utilizes a battery as its power source or obtains electrical power from some other source, such as an electrical wall outlet. The pumping apparatus 110 may additionally comprise a flow control mechanism 111 which, for example, may be designed to simulate the average flow rate of blood through the host vascular system. The pumping apparatus 110 may be designed to pump liquid through liquid tubing line 103a continuously or may be on a timer. For example, the pumping apparatus 110 may be programmed to dispense or pump liquid substance from the liquid supply 106 based on natural behavioral patterns of the target insect, such as feeding patterns or the programming may be based on presence of the host. Alternatively, the pumping apparatus may be manually turned on or off and flow rate adjusted. The pumping apparatus may be treated such that it is chemical resistant.

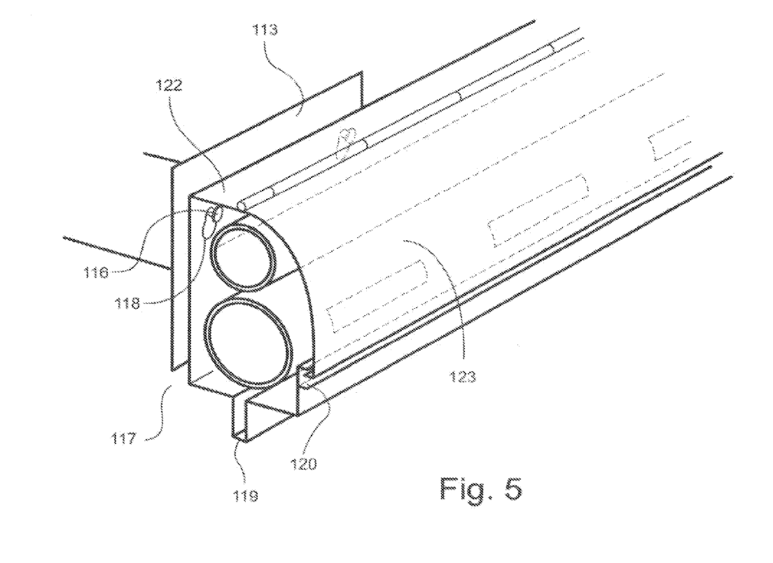

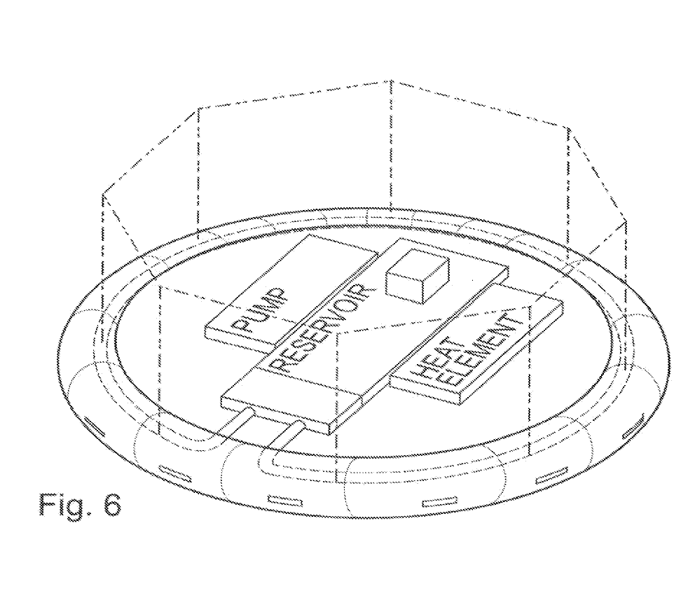

It is understood that the insect exterminating device may be a free standing, self contained device, such as depicted in FIG. 6 or designed wherein tubing segments 101 extend from the liquid and gas supplies to multiple locations within a room. Alternatively, gas and liquid supplies may be built into the walls of a room at one or more locations. Said gas and liquid supplies may be accessible via outlets which receive tubing segments for distribution of liquid and gas throughout the room

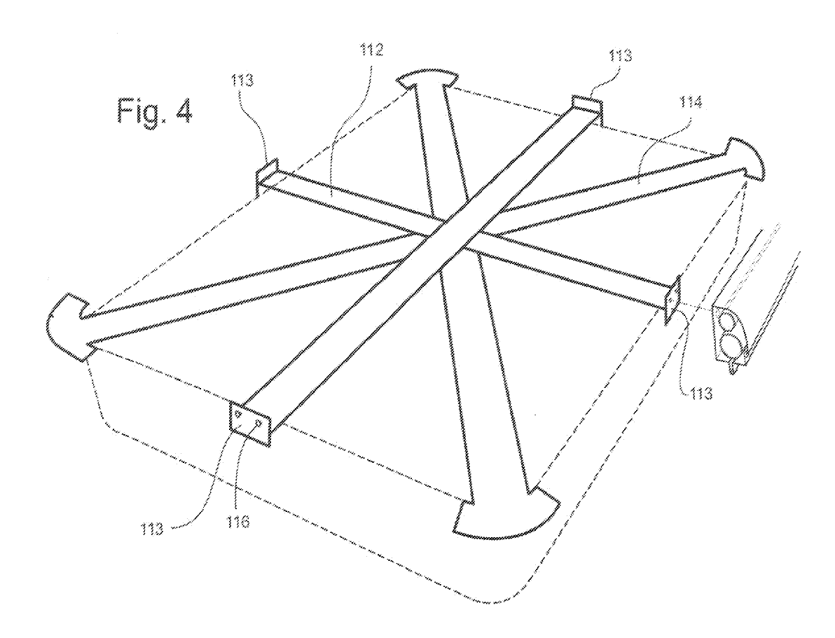

In one embodiment, a tube support assembly 112 may be used to attach tube segments 101 to any solid structure, such as beds, chairs, tables and the like. Any method to support tubing segments 101 may be used, including clips, plates, Velcro strips, straps, brackets, double sided adhesive, and the like. FIGS. 1 and 4 illustrate an example of how the insect extermination device 100 may be used with a common bed. In this embodiment, tube support assembly 112 comprises one or more plates 113 attached to one or more straps 114 resting underneath the mattress 115. In another embodiment, straps 114 may extend around the perimeter of the mattress. Plates 113 are positioned near the side of the mattress or box spring. Straps 114 may include mechanisms for adjusting the tension of strap 114. Alternatively, straps 115 may be made of elastic or some other material that is stretchable. Tightening straps 114 stabilizes the tube support assembly 112 and plates 113 on the solid support structure.

Referring now to FIGS. 4 and 5, in one embodiment, plates 113 comprise mounting tabs 116 on their outer face for mounting insect trap 117, which is a part of the overall tube support assembly 112, to plate 113. Mounting tabs 116 insert into mounting slots 118 on the side of the insect trap 117 facing the mattress or its back side. Insect trap 117 may be mounted to tube support assembly 112 applying any mechanism or method known to those of skill in the art. For example, Velcro mounting may be used wherein Velcro is added to the back of insect trap 117 as well as to the mattress. Additionally, Velcro mounting may be used exclusive of straps. In another embodiment, a clip may be attached to a metal bed flame, for example. Like the plate 113, the clip may contain tabs that insert within matching slots or holes in the insect trap 117, wherein the insect trap 117 mounts to said clip.

In another embodiment of the insect exterminating device, the tube support assembly 112 may be mounted to a wall or walls within a room. For example, plates 113 may be mounted directly to the walls, which in turn provide a support for the insect trap 117. It may be preferable for aesthetic purposes to conceal or partially conceal the tube support assembly 112 when applied in this manner. In such circumstances, ordinary molding or baseboards may be used to conceal said assembly.

Referring now to the embodiment illustrated in FIG. 5, insect trap 117 is designed to house liquid and gas lines. Furthermore, the embodiment shown in FIG. 5 comprises a trap 119 for capturing insects that enter an opening in insect trap 117. The insect trap 117 may be made of any material known to those of skill in the art, including but not limited to plastics, metals, synthetic fabrics, metal alloys and the like. The insect trap 117 depicted in FIG. 5 is shaped like a flattened bottom “D” and comprises an entrance 120. Entrance 120 may be any size as long as the target insect is allowed access to the components of insect trap 117. Preferably, the entrance is large enough to accommodate the target insect and small enough to prevent probing human fingers from gaining access to insect trap 117. Furthermore, entrance 120's size may vary depending on the target insect. For example, a larger entrance 120 may be designed for Reduviddae Triatominae, or the cone nose assassin bug, which transmits Chagas disease common in Central and South America. Entrance 120 must be large enough to allow the target insect to sense the attractant, such as carbon dioxide and/or the heat emitted from the liquid inside the tubing, and allow the insect to easily crawl inside. In the case of bedbugs or other blood sucking insects, entrance 120 may be small enough to prevent an engorged insect from exiting.

As mentioned above, insect trap 117 houses the tubing segments 101, for example liquid and gas lines. Tubing segments may rest inside or outside insect trap 117. Alternatively insect trap 117 may comprise interior features which are designed to support tubing segments. For example, insect trap 117 may contain built in brackets that hold tubing segments in place, or alternatively tubing segments may be glued to the insect trap 117 interior surface. Insect trap 117 may comprise a single continuous unit attached to and surrounding the solid support surface, such as a bed or wall, or the insect trap 117 may comprise one or more discrete units positioned around the perimeter of the solid support. Said discrete units may be snapped together to form a continuous trap 117 or they may each be separated by a predetermined distance.

Referring to FIG. 5, for ease of installation and changing of tubing segments in insect trap 117, insect trap 117 may have a hinged surface that may be opened allowing access to the interior of the insect trap. In one embodiment, the hinged surface comprises an outer face 121 of the insect trap 117. Alternatively, outer face 121 of the insect trap 117 may not be hinged, but rather may be attached to the insect trap 117 by tension clips or other suitable means, whereby a user may detach the outer face 121 from the insect trap 117 completely.

With continued reference to FIG. 5, insect trap 117 may comprise a pitfall trap 119 near the entrance 120 into which a target insect may climb or fall. Pitfall trap 119 may be located on the bottom surface of the insect trap 117 wherein the target insect enters the insect trap 117 through entrance 120 and falls or slides into pitfall trap 119. In such a scenario, assuming the target insect had not yet ingested the active agent or toxicant, extermination may occur through dehydration or starvation. The surface of the pitfall trap 119 may be made of material that is difficult for the target insect to climb. For example, the interior surface may be made of powder coated plastics. For good climbing insects, such as certain subspecies of Cimex, which are able to climb out of pitfall trap 119, the insect will follow the chemical gradient (e.g. CO2, pheromone, etc.) from gas tubing line 103b until near liquid tubing line 103a. Alternatively, the insect will be within range to utilize its heat tracking sense and detect the heated liquid flowing through the liquid tubing line 103a. The target insect must be within approximately 30 cm of the liquid flowing through liquid tubing line 103a in order to use its heat tracking sense to guide it to the liquid tubing line 103a. Entrance 120 may be made wider in insect trap 117 to allow heat sensing from greater distance.

Tubing segments 101 may be positioned within insect trap 117 near the entrance or at a distance from the entrance 120 depending on the ultimate goal. For example, tubing segments may be placed very close to the entrance 120 if the object is simply to exterminate the insect via liquid active agent or toxicant. Target insect may feed from the tubing segment 101 and then exit, without falling into pitfall trap 119. However, if the object is to trap the target insect, then tubing segment 101 may be positioned at a larger distance from entrance 120. This would allow the target insect to fall inside the pitfall trap 119 before they were allowed to feed from tubing segment 101.

In addition to the function of supporting the tubing segment 101, insect trap 117 may have any number of additional features depending on the behavioral characteristics of the target insect. For example, the insect trap 117 may include tape or some other surface on the exterior of insect trap 117 for climbing ease. Additionally, insect trap 117 may contain an attachment means on its top surface 122, such as Velcro, for mosquito netting for comprehensive protection against crawling and flying insects. In another embodiment, insect trap 117 may contain a top entrance allowing access of flying, insects, such as mosquitoes. biting flies, and other flying ectoparasites (external blood feeder) to liquid tubing line 103a.

It will be realized that the foregoing embodiment of the present invention has been shown and described for the purposes of illustrating the functional and structural principles of this invention and are subject to change without departure to such principles. Therefore, this invention includes all modifications encompassed within the spirit and scope of the following claims.

What is claimed is:

1. An insect extermination device comprising:
interconnecting tubing segments connected by a connector;
said interconnecting tubing segments comprising a gas tubing line and a liquid tubing line wherein a gas and liquid substance flows through said tubing segments;
a liquid supply and a gas supply; and
a tube support assembly for attaching the interconnecting tubing segments to a solid structural support wherein said interconnecting tubing segments conform to the shape and size of the solid structural support.

2. The insect extermination device of claim 1 wherein said gas substance is carbon dioxide.

3. The insect extermination device of claim 1 wherein said liquid substance contains at least one toxicant.

4. The insect extermination device of claim 1 wherein said tube support assembly comprises a tubing support with a pitfall trap for the insects.

5. The insect exterminating device of claim 1 wherein said gas and liquid supply are pressure controlled.

6. The insect exterminating device of claim 1 wherein said gas and liquid supply comprise a timing mechanism for release of gas and liquid substances into interconnected tubing segments.

7. The insect exterminating device of claim 1 wherein said liquid supply is temperature Controlled.

8. The insect exterminating device of claim 1 wherein said liquid substance is heated to a temperature of about 94° F. to about 106° F.

9. The insect exterminating device of claim 1 wherein said liquid substance is heated to a temperature of about 98.6° F.

10. The insect exterminating device of claim 1 wherein said liquid line is wrapped with thermal resistant wire to regulate the temperature of the liquid substance.

11. The insect exterminating device of claim 1 wherein said liquid line is insulated.

12. The insect exterminating device of claim 1 wherein said liquid line contains openings to allow insect exposure to liquid substance said openings covered with a self sealable membrane.

13. An insect extermination device comprising:
interconnecting tubing segments;
said interconnecting tubing segments comprising a gas tubing line and a liquid tubing line wherein a gas and liquid substance flows through said tubing segments;
a tube support assembly for attaching the interconnecting tubing segments to a solid structural support; and
said tube support assembly comprising a tubing support for supporting said gas tubing line and liquid tubing line and a pitfall trap.

14. The insect exterminating device of claim 13 wherein said liquid tubing, line contains openings to allow insect exposure to the liquid substance said openings covered with a self sealable membrane.

15. The insect exterminating device of claim 13 wherein said liquid substance is heated to a temperature of about 95° F. to about 104° F.

16. The insect exterminating device of claim 13 wherein said liquid line is heated to a temperature of about 98.6° F.

17. The insect extermination device of claim 13 wherein said gas substance is carbon dioxide.

18. The insect extermination device of claim 13 wherein said liquid substance contains a toxicant.

19. An insect exterminating device comprising:
interconnecting tubing segments;
said interconnecting, tubing segments comprising a gas tubing line and a liquid tubing line; and
a tube support assembly for attaching the interconnecting tubing segments to a solid structural support.

20. The insect exterminating device of claim 19 wherein said liquid tubing line contains openings to allow insect exposure to the liquid substance said openings covered with a self sealable membrane.
